(19) United States
(12) Patent Application Publication
(10) Pub. No.: US 2003/0024270 A1
(43) Pub. Date: Feb. 6, 2003

(54) Method of separating beads from a strand of plastic glass

(76) Inventors: Hans-Jurgen Leidecker, Zornheim (DE); Otmar Schmittel, Hamm (DE); Ralf Reiter, Mainz-Kastel (DE)

Correspondence Address: Pauley Petersen Kinne & Erickson, 2800 W. Higgins Road, Suite 365, Hoffman Estates, IL, 60195, US

(21) Appl. No.: 10/191,391

(22) Filed: Jul. 8, 2002

(30) Foreign Application Priority Data
Jul. 7, 2001 (DE) 101 33 047.2

(51) Int. Cl. C03B 7/12

(52) U.S. Cl. 65/133

(57) ABSTRACT

A method for separating beads from a strand of plastic glass, which emerges continuously from a storage unit, wherein the glass strand passes a periodically controllable glass cutter, and the beads are separated from the glass strand in cutting phases. The separated beads are received by molds which are displaced beneath the glass cutter at a timed rate of conveyance, which is adapted to a cutting sequence of the glass cutter, an emerging speed of the glass strand and a desired size of bead. The control of the glass cutter includes, in the periods, two different cutting phases for alternately separating useful beads and waste beads, and the waste beads are easily discharged between the conveyed molds.

### BACKGROUND OF THE INVENTION

1. Field of the Invention

This invention relates to a method for separating beads from a strand of plastic glass, which emerges continuously from a storage unit, wherein the glass strand passes a periodically controllable glass cutter, and the beads are separated from the glass strand in cutting phases. The separated beads are received by molds which are displaced beneath the glass cutter at a timed rate of conveyance, which is adapted to the cutting sequence of the glass cutter, the emerging speed of the glass strand and the desired size of bead.

2. Description of Related Art

In this method of portioning beads, the control of the glass cutter is particularly critical. As shown in German Patent References DE-AS 28 18 234 and DE 34 01 011, complex driving means for driving the glass cutter are used for such purpose. In such case, the cutter arms are also driven differently.

In the case of the methods using these known glass cutters, there is no guarantee that the beads are separated in such a manner that no material falls between the molds, and in such a manner that the separated beads form striae in the mold, and thus in the product. This is particularly disadvantageous when the beads are used in the molds for manufacturing glass for spectacles.

### SUMMARY OF THE INVENTION

One object of this invention is to provide a method of the type described above, but which can ensure that the separated beads are fully conducted into the prepared molds, that the space between the molds remains free of plastic glass particles, and that the portioning of the glass strand and thus the size of bead are selectable.

This object is achieved, according to this invention, by having one cutting phase, with a prescribed or predetermined locking time for separating a useful bead and for retaining the subsequent glass strand, and one respective temporary cutting phase for separating the retained part of the glass strand as a waste bead and for releasing the subsequent non-retained part of the glass strand for the next useful bead are incorporated in each period for controlling the glass cutter. The rate of conveyance of the molds is adapted so that the waste beads are each discharged between molds which succeed one another, and the useful beads are each introduced into the next mold which is prepared beneath the glass cutter.

The two different cutting phases divide the glass strand into useful beads and waste beads. Because of the cutting phase with the prescribable or prescribed locking time, the useful beads can be continuously introduced into the prepared molds without any adverse effect caused by a retention of the glass strand. However, the subsequent glass strand is retained in this cutting phase and held back until the next mold for accommodating the next useful bead is prepared. In the meantime, however, the retained part of the glass strand can pass, as a waste bead, through the space between the molds on the conveyor and can thus be discharged without any risk of pollution caused by adhesion. The useful beads are always continuously introduced into the prepared mold without the beads containing any regions which have a tendency to form striae. This is one great advantage of this method, and this advantage can be achieved solely by controlling the glass cutter in periods having two different cutting phases.

Because of the adaptation of the timed rate of conveyance of the molds, and because of the cutting periods of the glass cutter, the desired size of the useful beads can be suitably achieved.

According to one embodiment, the locking time is selected to be about 1 to 3 sec., while the temporary cutting phase is fixed at about 0.9 sec.

The size of the useful beads is selectable. The size of the useful bead is determined by the emerging speed of the glass strand, the weight of the glass strand per unit of length and the opening time of the glass cutter between the two cutting phases.

The method can be used particularly for controlling a glass cutter which is operated at a cutting speed of 2-7 useful beads/minute and with a useful bead sample of 170-220 g. It is also highly suitable for forming useful beads from highly viscous glass strands.

If the glass cutter is driven by means of an electric servomotor, which can be set to different opening widths of the glass cutter, then the blade pressure of the glass cutter can be regulated. Such arrangement prevents the blades from sliding together, which might lead to glass filaments or overlappings in the glass because parts of the glass strand are pushed one on top of the other.

German Patent Reference 101 33 047.2, the priority document corresponding to this invention, and its teachings are incorporated, by reference, into this specification.

1. In a method for separating beads from a glass strand of plastic glass emerging continuously from a storage unit, wherein the glass strand passes a periodically controllable glass cutter, and the beads are separated from the glass strand in cutting phases, and wherein the separated beads are received by molds which are displaced beneath the glass cutter at a timed rate of conveyance which is adapted to a cutting sequence of the glass cutter, an emerging speed of the glass strand and a desired size of bead, the improvement comprising:
during each period for controlling the glass cutter, having one cutting phase with a prescribed locking time for separating a useful bead and for retaining the subsequent glass strand, and one respective temporary cutting phase for separating a retained part of the glass strand as a waste bead and for releasing a subsequent non-retained part of the glass strand for a next useful bead, and the rate of conveyance of the molds is adapted so that waste beads are each discharged between the molds which succeed one another, and each said useful bead is introduced into the next mold which is prepared beneath the glass cutter.

2. In the method according to claim 1, wherein the locking time is about 1 to 3 seconds, and the temporary cutting phase is fixed at about 0.9 second.

3. In the method according to claim 2, wherein a size of the useful bead is determined by the emerging speed of the glass strand, the weight of the glass strand per unit of length and an opening time of the glass cutter between two cutting phases.

4. In the method according to claim 3, wherein the glass cutter is driven by an electric servomotor which can be set to different opening widths of the glass cutter.

5. In the method according to claim 4, wherein a cutting speed of 2-7 useful beads/minute and a useful bead size of 170-220 grams are used.

6. In the method according to claim 5, wherein highly viscous glass strands are used to form the useful beads.

7. In the method according to claim 1, wherein a size of the useful bead is determined by the emerging speed of the glass strand, the weight of the glass strand per unit of length and an opening time of the glass cutter between two cutting phases.

8. In the method according to claim 1, wherein the glass cutter is driven by an electric servomotor which can be set to different opening widths of the glass cutter.

9. In the method according to claim 1, wherein a cutting speed of 2-7 useful beads/minute and a useful bead size of 170-220 grams are used.

10. In the method according to claim 1, wherein highly viscous glass strands are used to form the useful beads.
